(19) United States
(12) Patent Application Publication
(10) Pub. No.: US 2022/0030833 A1
(43) Pub. Date: Feb. 3, 2022

(54) SELF-ORIENTING ANIMAL COLLAR WITH PROGRAMMABLE MODULAR ELECTRONIC COMPONENTS

(71) Applicant: Scollar, Inc., Kansas City, MO (US)

(72) Inventors: John Fitzgerald Kennedy, Kansas City, MO (US); Jeffrey Lamar Kelsoe, Palm Desert, CA (US); Joseph Benjamin Moak, San Carlos, CA (US); Yuri Viacheslav Litvinov, San Francisco, CA (US); Tadd Michael Scarpelli, Libertyville, IL (US); Herman Bryant Elliott, Atlanta, GA (US); Lisa René Tamayo, Kansas City, MO (US)

(21) Appl. No.: 17/499,742

(22) Filed: Oct. 12, 2021

Related U.S. Application Data
(63) Continuation-in-part of application No. 15/047,985, filed on Feb. 19, 2016, now Pat. No. 11,140,872.
(60) Provisional application No. 62/118,068, filed on Feb. 19, 2015.
(60) Provisional application No. 63/230,444, filed on Aug. 6, 2021.

(51) Int. Cl. A01K 27/00; A01K 29/00; A01K 11/00

(52) U.S. Cl. CPC A01K 27/001; A01K 11/008; A01K 29/005; A01K 27/009

(57) ABSTRACT

Disclosed modular animal collar systems include a D ring exoskeleton system, a breakaway latch tongue system and other systems. Disclosed collars may be self-orienting. Disclosed collars include auto release systems to ensure that collars do not choke or otherwise injure a pet. Collars include sophisticated electronics to commutate with a pet owner's smart phone but also include means of communication not requiring the use of a smart phone. Collars may include a base collar containing a micro controller and other computer related components. Surrounding modular components may contain additional equipment and may be added as needed by a pet owner. Disclosed collar functions are executed by the disclosed collars and facilitate the retrieval, care and training of a pet.

### CROSS-REFERENCE TO RELATED APPLICATIONS

The present application claims the benefit of and priority of U.S. Provisional Application Ser. No. 63/230,444 , filed on Aug. 6, 2021, entitled “SELF-ORIENTING ANIMAL COLLAR WITH PROGRAMMABLE MODULAR ELECTRONIC COMPONENTS,” and also claims the benefit of and priority of U.S. patent application Ser. No. 15/047,985, filed on Feb. 19, 2016, entitled “ANIMAL COLLAR WITH PROGRAMMABLE MODULAR ELECTRONIC COMPONENTS”, now U.S. Pat. No. 11,140,872 and issued on Oct. 12, 2021, which claims the benefit of and priority of U.S. Provisional Application No. 62/118,068, filed on Feb. 19, 2015, entitled “ANIMAL COLLAR WITH PROGRAMMABLE MODULAR ELECTRONIC COMPONENTS,” the entire disclosures of which are incorporated by reference herein.

### FIELD

The present disclosure relates generally to animal accessories. More particular, the disclosure relates to means and methods of creating a self-orienting modular animal collar system.

### BACKGROUND

Animal collars, such as dog and cat collars have been used for restraint, identification and other uses. Many dog and cat collar uses have been known over the last century and include tracking, training, monitoring, applying an electrical or vibrational stimulation, and providing pet door access for the animal. There are now many single purpose animal collars on the market that comprise electronics and software. Many collars may also provide tracking via a tracking device using a Global Position System (“GPS”). Such tracking devices are susceptible to signal interference or loss of signal when the tracking device is not facing the atmosphere or sky (e.g., the tracking device is facing the ground). It is common for a pet owner to have several single use animal collars for their pet's various needs.

Conventional collars have failed to adapt to the Digital Age. Conventional collars lack standardized or open-source software and hardware systems. Conventional collars are of single use and are comprised of “closed” or propriety electronic systems that prohibit system amendments or expansion.

Conventional collars also fail to provide modular designs and fail to communicate with current smart phone systems. Conventional collars also fail to provide effective mechanical or electromechanical means of detachment in the event that the collar becomes ensnared or otherwise starts to choke the wearer of the collar.

Conventional collars that provide tracking fail to remain in an optimal position for GPS tracking when installed on a pet.

Thus, there is a need for the presently disclosed systems.

### SUMMARY

Disclosed embodiments overcome shortfalls in the art by providing a modular collar system that may comprise a base collar or base module with the base collar comprising microcontrollers (such as MCU), memory, GPS, nine-axis motion sensors, visual graphic displays, using LED and other means, a modular bus system to power and operate interchangeable collar modules, a battery module connection port and communication systems such as Bluetooth Low Energy (such as BLE) communications.

Disclosed modules or interchangeable collar components may be accessible from the inside surface of the collar so as to protect the modules from environmental factors and unintended removal. Command and control systems within the modules may be controlled by open-source firmware and software so as to allow third parties to create new functionality.

Various collar systems are disclosed and contemplated. For example, a breakaway no leash version features a safety mechanism that allows the collar to open and release upon the application of a predetermined amount of pull or pressure upon the collar. A D-ring exoskeleton embodiment is also disclosed and may use a load cell assembly to enable actions to be automatically taken given a predetermined amount of pull such as electronic shock or sound played from speaker.

A breakaway-latch tongue system prevents strangulation, sends an electronic signal when the collar has self-released.

A breakaway-latch tongue system may comprise a breakaway-latch tongue portion of the collar that includes two male portions on either end. The first male portion is for the breakaway feature that includes a magnet to activate the female portion of the breakaway to signal whether the breakaway is closed or open. The second male portion includes teeth that vary the circumference of the collar to fit the pet by sliding in and out of the female portion that includes teeth comporting to the latch system. Multiple lengths of the breakaway-latch tongue allow for the collar to be sized further beyond just the length of the latch teeth.

Disclosed embodiments overcome shortfalls in the art by use of a detachable battery system, the batter system may comprise the use of one or more standard 2.5 mm four conductor jack connections or other connection for both physical attachment and electrical conductivity. Disclosed battery systems may be attached to a module to eliminate battery heat upon a collar base, use a standard O-ring seal, maximize surface area for heat dissipation and have a mounting system to articulate and deflect in response to a pet's movements. The manufacture of a disclosed battery system minimizes battery degradation as the manufacturing process eliminates exposing the battery to molding temperatures. A battery latch release is designed for human use and not pet use, thus reducing the risk of accidental release by pets.

Disclosed embodiments overcome shortfalls in the related art by presenting an unobvious and unique combination and configuration of methods and components to construct a modular appendage encircling collar that secures around an animal's neck. The presently disclosed embodiments include a central module that comprises a microcontroller or central processing unit, memory, a graphical display screen, wireless communication such as Bluetooth, WiFi and low power long range, global positioning satellite (GPS) receiver, an assortment of sensors such as accelerometer, gyroscope, magnetometer, geomagnetic, gravity, temperature, humidity, atmospheric pressure, force measuring load cells, lights including visible and ultraviolet, one or more microphones, one or more speakers including those able to emit ultrasonic sound heard by dogs, a vibration motor, and additional components. The list of these various components is not exhaustive. The various components may reside within a central module or an auxiliary module.

The present invention overcomes shortfalls in the art by providing the central module means of power and communication transmission to a plurality of auxiliary modules that may attach to a common dog or cat collar strap. Auxiliary modules may share a power line and/or communication line with the central module. Each auxiliary module may be of a single function or comprise multiple functions. A contemplated embodiment includes the use of a battery auxiliary module with means of conversion of movement to power and power storage. Auxiliary modules may comprise sensors as described above. Auxiliary modules may comprise third party applications and/or hardware as the software and firmware of the central module may comprise open source applications and protocols.

Auxiliary modules may be connected to or communication with the central module by any means including USB, SPI, I2C, Bluetooth and others.

The central module may comprise an open application programming interface (API) that allows users and third-parties to create additional software applications that provide additional functionality. Auxiliary modules may also include additional APIs to enable an auxiliary module's attributes.

Auxiliary module attributes may include any function and may include functions complementary to those of the central module.

Embodiments of the invention may also include the use of electric shock to the animal, machine to machine communication (cellular) with removable SIM card, electric energy generation, invisible fence sensor, pet door activation, image camera for video and still imagery, light emitting and reflecting systems, and user or third-party created modules.

A variety of central module and auxiliary module shapes are available to provide different uses including conductive contacts that make contact with an animal's skin for shock collar modules and vital measurements of the animal, LED “antennae” for visibility of long hair animals, and configurations that allow for large electronic packages. An LED antenna and/or antennae system may also be used for and/or configured to make an animal more visible to scare off other animals. Disclosed embodiments include modules with displays are designed to have the displays angled to minimize contact and force of animal's claws during scratching actions.

Disclosed embodiments may be controlled and/or monitored by a graphical user interface on the animal collar's display, through applications on mobile phones running Apple's iOS, Google's Android, and Microsoft's Windows operating systems, as well as from a web page or web interface accessed over the Internet. Disclosed embodiments may include a graphical display capable of displaying images and text as well as a speaker are included in the collar as human interface output. A microphone and a 9-axis motion sensor are included in the collar as human interface devices for input.

Disclosed embodiments enable new functionality to be added to the collar by adding new modules or writing new applications that run on the collar, mobile phone, web site, or a combination of these. The mobile phone and web site collar software also displays apps that have been created by third-parties and made available for free or for a small fee.

Disclosed embodiments provide for a self-orienting collar system, comprising a collar comprising at least one strap; a tracking device positioned on the collar; a bottom assembly positioned on the collar opposite the tracking device, the bottom assembly having a weight greater than a weight of the tracking device; and an adjustment assembly for adjusting a diameter of the collar, wherein the tracking device and the bottom assembly remain positioned opposite each other when the diameter of the collar is adjusted.

The bottom assembly may include a battery for supplying power to the tracking device. The battery may be removable from the bottom assembly. The system may further comprise a writing harness integrated with the collar and configured to deliver power from the battery to the tracking device.

The tracking device may comprise or more antennas for receiving tracking information from a Global Positioning System.

The system may further comprise a first housing configured to house the tracking device and a second housing configured to house the bottom assembly.

The adjustment assembly may comprise a central gear coupled to a right-side gear and a left-side gear, wherein rotation of the central gear causes the right-side linear gear and the left-side linear gear to at least one of extend or retract from the central gear, thereby increasing or decreasing a diameter of the collar.

The weight of the bottom assembly may cause the bottom assembly to face a ground and the tracking device to face a sky opposite the ground when the collar is installed on a neck of a pet.

The system may further comprise further comprises at least one auxiliary module configured to receive power from the battery.

The at least one auxiliary module may comprise sensors, the sensors comprising at least one of motion sensors, microphones, or heartrate sensors.

Disclosed embodiments provide for a self-orienting collar system comprising: a collar comprising at least one strap; a tracking device positioned on the collar; a bottom assembly positioned on the collar opposite the tracking device, the bottom assembly having a weight greater than a weight of the tracking device; and an adjustor for adjusting a diameter of the collar, the adjustor comprising the at least one strap and a slide, the slide configured to adjust a length of the at least one strap, wherein the tracking device and the bottom assembly remain positioned opposite each other when the diameter of the collar is adjusted.

The bottom assembly may include a battery for supplying power to the tracking device. The system may further comprise a writing harness integrated with the collar and configured to deliver power from the battery to the tracking device.

The tracking device may comprise one or more antennas for receiving tracking information from a Global Positioning System.

The system may further comprise a first housing configured to house the tracking device and a second housing configured to house the bottom assembly.

The weight of the bottom assembly may cause the bottom assembly to face a ground and the tracking device to face a sky opposite the ground when the collar is installed on a neck of a pet.

The system may further comprise further comprises at least one auxiliary module configured to receive power from the battery.

The at least one auxiliary module may comprise sensors, the sensors comprising at least one of motion sensors, microphones, or heartrate sensors.

Disclosed embodiments provide for a self-orienting collar system, comprising a collar comprising at least one strap; a tracking device positioned on the collar; at least one auxiliary module; a bottom assembly positioned on the collar opposite the tracking device and comprising a battery configured to supply power to the tracking device and the at least one auxiliary module, the bottom assembly having a weight greater than a weight of the tracking device; and an adjustment assembly for adjusting a diameter of the collar, wherein the tracking device and the bottom assembly remain positioned opposite each other when the diameter of the collar is adjusted.

The at least one auxiliary module may comprise sensors, the sensors comprising at least one of motion sensors, microphones, or heartrate sensors.

The adjustment assembly may comprise a central gear coupled to a right-side gear and a left-side gear, wherein rotation of the central gear causes the right-side linear gear and the left-side linear gear to at least one of extend or retract from the central gear, thereby increasing or decreasing a diameter of the collar.

These and other objects and advantages will be made apparent when considering the following detailed specification when taken in conjunction with the drawings.

This Summary is neither intended nor should it be construed as being representative of the full extent and scope of the surgical sleeve of the present disclosure. The present disclosure is set forth in various levels of detail in the Summary as well as in the attached drawings and the Detailed Description and no limitation as to the scope of the present disclosure is intended by either the inclusion or non-inclusion of elements or components. Additional aspects of the present disclosure will become more readily apparent from the Detailed Description, particularly when taken together with the drawings.

The above-described embodiments, objectives, and configurations are neither complete nor exhaustive. As will be appreciated, other embodiments of the disclosure are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

### BRIEF DESCRIPTION OF THE DRAWINGS

The accompanying drawings, which are incorporated in and constitute a part of the specification, illustrate embodiments of the disclosure and together with the Summary given above and the Detailed Description of the drawings given below, serve to explain the principles of these embodiments. In certain instances, details that are not necessary for an understanding of the disclosure or that render other details difficult to perceive may have been omitted. It should be understood, of course, that the disclosure is not necessarily limited to the particular embodiments illustrated herein. Additionally, it should be understood that the drawings are not necessarily to scale.

FIG. 1 depicts a perspective view of a modular animal collar;

FIG. 2 depicts a front view of a modular animal collar;

FIG. 3 depicts a perspective view of a modular animal collar in an open position;

FIG. 4 depicts a perspective view of a latch tongue;

FIG. 5 depicts a collar and battery assembly in a detached position;

FIG. 6 depicts a collar with microphones;

FIG. 7 depicts a collar with microphones;

FIG. 8 depicts a collar with a module removed;

FIG. 9 depicts a collar with a display screen;

FIG. 10 depicts a collar with a speaker system;

FIG. 11 depicts an exposed speaker system;

FIG. 12 depicts a collar in a D ring exoskeleton configuration in a detached position;

FIG. 13 depicts a collar in a D ring exoskeleton configuration in a closed position;

FIG. 14 depicts a D ring and load cell;

FIG. 15 depicts a schematic view of a disclosed embodiment and related communication systems;

FIG. 16 depicts a perspective view of a disclosed embodiment;

FIG. 17 depicts an underside perspective view of a disclosed embodiment;

FIG. 18 depicts plan view of a disclosed embodiment;

FIG. 19 depicts an enlarged plan view of a disclosed user interface or display system;

FIG. 20 depicts a latch tongue base and related components;

FIG. 21 depicts a collar;

FIG. 22 depicts a load cell system integrated into a collar;

FIG. 23 depicts a load cell system;

FIG. 24 depicts a collar and load cell system; and

FIG. 25 depicts an exploded view of a load cell system;

FIG. 26 depicts a system for tracking a collar according to at least one embodiment of the present disclosure;

FIG. 27 depicts a right-side view of a self-orienting collar according to at least one embodiment of the present disclosure;

FIG. 28 depicts a left-side view of a self-orienting collar according to at least one embodiment of the present disclosure;

FIG. 29 depicts a rear view of an adjustment assembly or adjustor according to at least one embodiment of the present disclosure.

FIG. 30 depicts a rear view of a self-orienting collar in a first configuration according to at least one embodiment of the present disclosure;

FIG. 31 depicts a rear view of a self-orienting collar in a second configuration according to at least one embodiment of the present disclosure;

FIG. 32 depicts a top view of a self-orienting collar according to at least one embodiment of the present disclosure;

FIG. 33 depicts a bottom view of a self-orienting collar according to at least one embodiment of the present disclosure;

FIG. 34 depicts a front view of a self-orienting collar with a battery detached according to at least one embodiment of the present disclosure; and

FIG. 35 depicts a bottom view of a self-orienting collar with a battery detached according to at least one embodiment of the present disclosure.

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

### REFERENCE NUMERALS IN THE DRAWINGS

100 an animal such as a dog or cat
200 a modular collar system
210 flexible collar base or connective band
250 axillary module with animal sensors or electric shock terminal
253 animal sensors or electric shock terminal
260 axillary module
270 central module
280 axillary module
290 axillary module
295 graphical interface or display of central module
300 GPS network
310 cellular or wireless network
320 WiFi network
400 electronic devices in communication with a modular collar system 200
450 Bluetooth wireless network
460 communication between collar and Bluetooth wireless network 450 and/or electronic devices 400
500 cloud storage systems
600 breakaway collar system
610 latch tongue
612 teeth upon a latch tongue
620 latch tongue base
622 lock insert of latch tongue base
624 void for lock insert 622, defined within the latch tongue body
630 latch tongue body
632 Hall effect sensor sometimes contained within the latch tongue body or other parts of a collar
640 screen of breakaway collar system
650 sound chamber
655 speaker
656 speaker cover section
657 ambient microphone
658 microphone of breakaway collar system
659 pet microphone
660 module of breakaway collar system
670 flex circuit of breakaway collar system
680 female section or female void of latch tongue assembly
682 lower lip of female section 680
684 upper arch of female section 680
685 void of female section, defined by the lower lip 682 and upper arch 684
686 ratcheting mechanism
700 battery pack
710 jack or other connector between battery pack and collar
800 exoskeleton collar
810 flexible outer shell component
820 module of exoskeleton collar
840 speaker of exoskeleton collar
850 display of exoskeleton collar
860 load cell assembly
863 load cell body
865 attachment void, defined within load cell body 863
867 D ring of load cell assembly
869 swivel pin of load cell assembly
870 fastener to retain swivel pin 869
900 system
902 collar system
904 one or more satellites
906 tracking device
908 sky
910 ground
912 battery
914 first strap
916 second strap
918 first housing
920 second housing
922 collar
924 bottom assembly
926 adjustment assembly or adjustor
928 slide
930 ring
932 buckle
938 central gear
940 right-side linear gear
942 left-side linear gear
946 electrical contacts
952 locking attachments
950 wiring harness

### DETAILED DESCRIPTION

The following detailed description is directed to certain specific embodiments of the disclosure. However, the disclosure can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

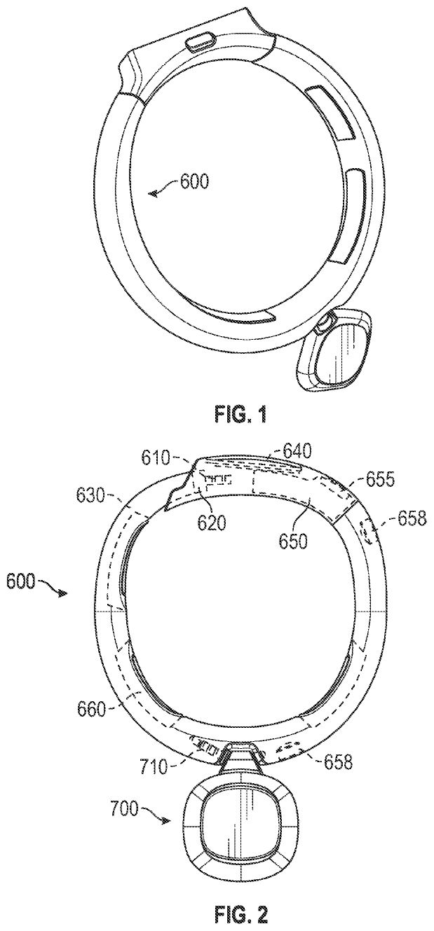

FIG. 1 depicts a perspective view of a disclosed breakaway collar system 600.

FIG. 2 depicts a breakaway collar system 600 having a latch tongue 610, latch tongue base 620, latch tongue body 630, a display screen 640, sound chamber 650, speaker 655, and various microphones that may include a microphone 658, a module 660 and other parts as shown and described herein. A collar system may include a removable battery pack 700, the battery pack may comprise a jack 710 or other attachment and/or electrical connection system.

Disclosed embodiments prevent pet strangulation, produce a signal upon auto release, may be produced in multiple sizes to comport with any neck size.

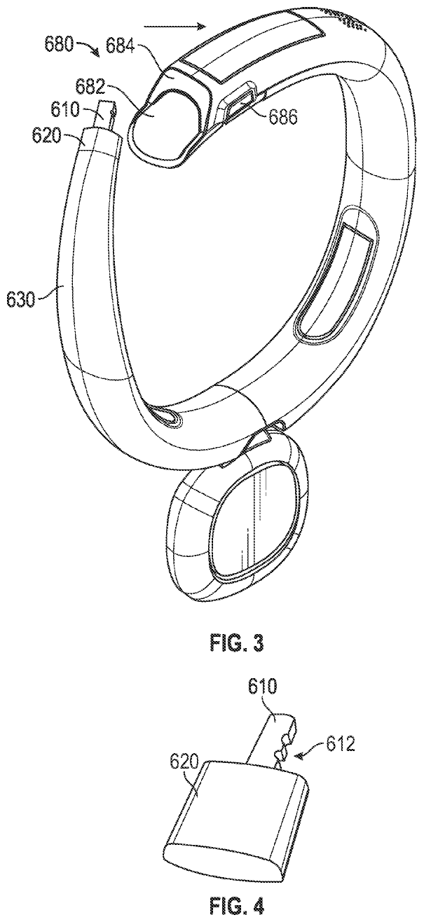

FIG. 3 depicts a perspective view of a modular animal collar in an open position wherein a latch tongue body 630 as a proximal end attached to the collar and a distal end attached to a latch tongue base 620 with the latch tongue base attached to a latch tongue 610. The latch tongue 610 may comport to a ratcheting mechanism 686 contained within the collar. The ratcheting mechanism 686 may be positioned near or adjacent to a female section 680 of a latch and tongue assembly. A female section of a latch and tongue assembly may be defined by a lower lip 682 and an upper arch 684. The lower lip 682 and upper arch 684 may be configured to provide sliding means of movement of the latch tongue base 620 and latch tongue 610 from an open position, as shown, and a locked position, secured within the ratcheting mechanism 686.

The ratcheting mechanism 686 may be set to a tension or mechanical setting to allow the latch tongue 610 to release upon a predetermined amount of tension upon the latch tongue body. This feature overcomes shortfalls in the related art as the collar will not remain attached if the collar is ensnared or otherwise threating to the safety of the wearer of the collar. The lower lip 682 may be convex in shape to comport with a smooth inner surface presented to the wearer and to facilitate a smooth mechanical movement to and from the ratcheting mechanism 686.

FIG. 4 depicts an expanded view of a latch tongue base 620 attached to a latch tongue 610, with the latch tongue having teeth 612 or other features to comport with the locking mechanisms of the ratcheting mechanism.

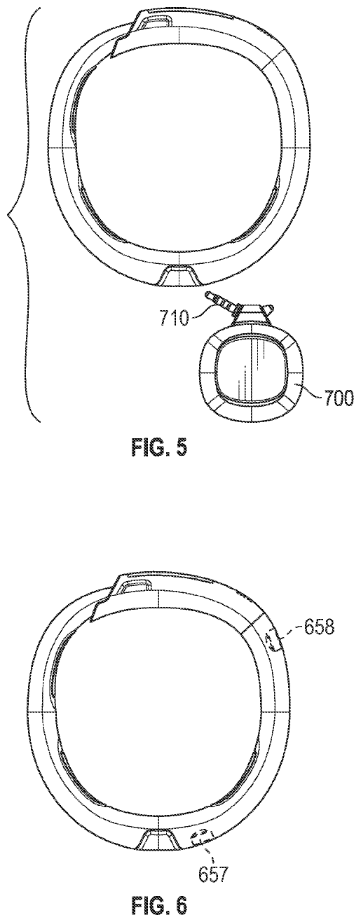

FIG. 5 depicts a collar detached from a battery pack 700, with the battery pack shown with means of attachment which may include a jack 710 or other means of mechanical or electrical attachment.

The battery pack 700 or the battery module is an external module that electrically connects to the collar using a 2.5 mm jack connection. This allows a battery to be removed and replaced without removing the collar from the pet. Another advantage over the prior art is that any heat generated by the battery during discharge is not in contact with the pet or the collar as the battery is physically isolated from the collar and pet. Additionally, due to the battery module design, the external battery module is not subjected to high heat during manufacturing due to not having an over-molded elastomer design.

FIG. 6 depicts a collar having a plurality of microphones which may include an ambient microphone 657 and standard microphone 658. The standard microphone may be configured to capture voice commands or sounds generated by an animal owner. The ambient microphone may be configured to capture ambient sound, with the ambient sound sometimes used in a noise cancellation system contained within the collar.

In a disclosed embodiment, a plurality of microphones are fully integrated into a collar to capture ambient sounds and sounds generated by the pet. On board electronics differentiate between pet noises and ambient sounds. In one embodiment, the collar contains two microphones. A first microphone is near the top of the collar and outward facing, picking up ambient sounds around the pet. A second microphone is on the inside bottom surface of the collar adjacent to the pets throat. The second microphone may receive the pet's own sounds including barks, meows, cries, breathing, and blood flow sounds.

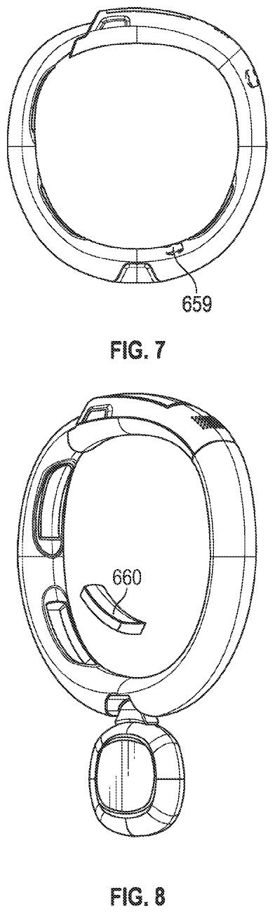

FIG. 7 depicts a collar having a pet microphone 659. A pet microphone may be configured to capture sound generated by a wearer of the collar.

FIG. 8 depicts a collar having modules, with a module 660 shown in a removed position.

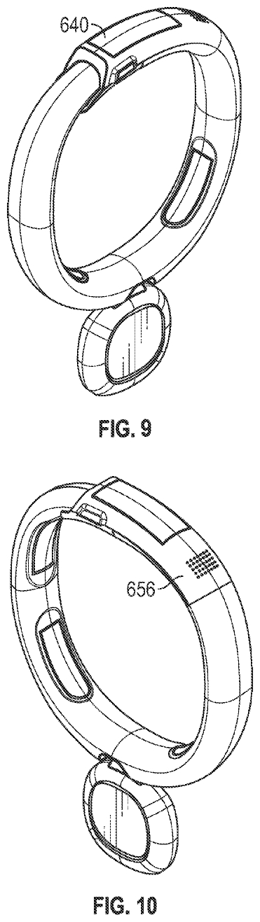

FIG. 9 depicts a collar with a display screen 640. The contents of the display screen include the contents of the screen in FIG. 19.

Disclosed display systems include the first OLED application on a pet collar and provides programmable means to display any graphic content. The display may include various lights for illumination for pet safety and a two-way interaction using a motion sensor. The display may disclose or project pet and owner information as well as license, rabies and other information. Vaccination, feeding and other reminder information may also be presented upon the display.

Interactivity and screen display features also include that ability of the system to sense a feeding of the pet. The time of the feeding may be displayed upon the display system so that other caretakers do not over feed the pet.

A display 640 may provide readable written notifications on the collar to alleviate the need for the pet owner or any human care giver to need a smartphone or other device to read the notification. Human interaction with the collar is confirmed through the graphical display for module activation, wireless signal strength, battery strength, reminder cancelation, feeding notifications and confirmations, and other items. The display is fully configurable via programming.

FIG. 10 depicts a collar with a speaker cover section 656. The speaker cover may protect in inner speaker.

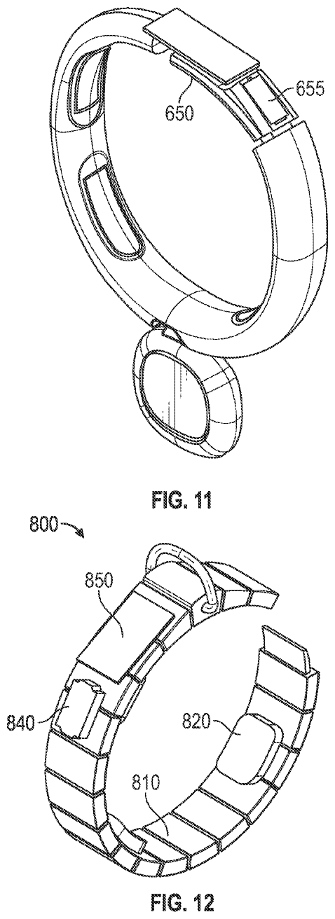

FIG. 11 depicts an inner or internal speaker 655. The speaker may be connected to a control center or other system accepting input from a system user. A speaker may transmit sound to a wearer of the collar or a bystander near the collar.

A disclosed speaker system may include a fully integrated speaker system that may include a resonant chamber integrated into a collar. In one disclosed embodiment, a small speaker is integrated into the collar along with a resonant chamber. This configuration ensures the speaker sounds are heard by the pet as well as humans in the surrounding area where the pet is located. The speaker may play a variety of sounds to communicate commands, audio markers for training, and alerts for humans for reminders as well as calls for help when the pet or collar is lost.

FIG. 12 depicts an exoskeleton embodiment 800 which may comprise a plurality of connected outer shell components 810 or flexibly attached links, one or more modules 820, one or more speakers 840 and one or more display screens 850.

An exoskeleton embodiment is a pet collar that includes an assortment of electronics to enable collar functionality to be expanded by adding additional electronic modules by connection to a common bus imbedded in the collar. The assortment of electronics and expandable modules allows the collar to have unlimited functionality

A disclosed exoskeleton dog collar 800 overcomes shortfalls in the art in many ways, such as distributing forces exerted upon internal circuitry and protecting exposed items such as the display and battery. The linking of the components allows for flexibility in the collar. In general, a D-ring collar will be subjected to very strong forces and the electronic circuitry of the collar will need to be protected from such forces. The exoskeleton structure of the dog collar isolates the forces caused by pulling on the D-ring, pulling anywhere on the collar, biting on the collar, or scratching of the collar from being transferred to the electronics of the collar. This ensures that the collar will be rugged enough to survive the harsh environment of a dog collar.

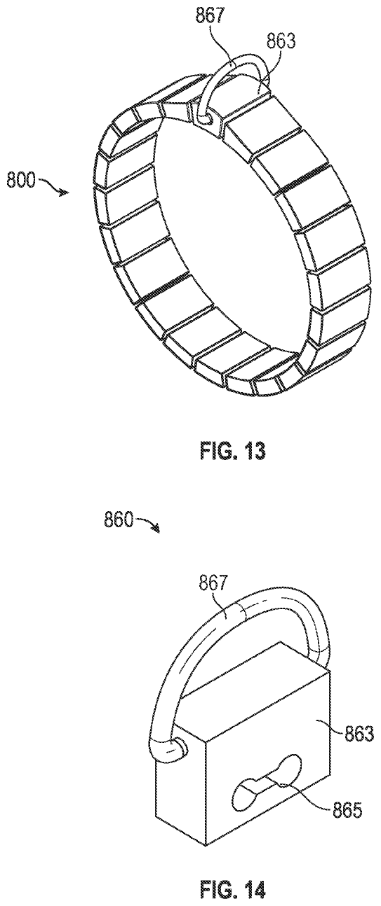

FIG. 13 depicts an exoskeleton embodiment 800 which may comprise a D ring 867 or other attachment configuration attached to a load cell body 863.

FIG. 14 depicts a load cell assembly 860 which may comprise a load cell body 863 with the load cell body containing or defining an attachment void 865. In general, a lip or male member may comport to the attachment void to secure the collar upon a wearer. The load cell assembly 860 may provide means of collar actions such as electronic shock or emitting sounds based on electronic signals when load cell is pulled.

A disclosed D ring may measure external or “pulling” forces exerted upon the leash. Force vectors may be measured and trigger a variety of actions. In a disclosed embodiment, a collar suitable for dogs and other animals includes a D-ring that is intended to be attached to a leash. The D-ring is connected to a load cell for measuring force electronically. This signal is used by the collar's electronics to trigger various collar module training systems such as electric shock, vibration, and audio sounds produced by the collar's speakers. This system may be used to assist in training the pet not to pull on the leash among other training lessons.

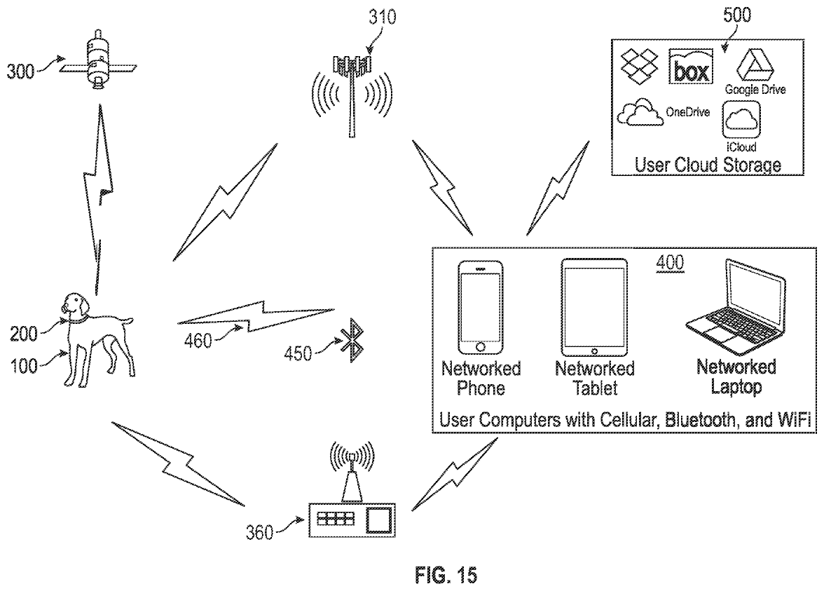

FIG. 15 depicts a disclosed system that may comprise a dog 100 or other animal wearing a modular collar system 200. The modular collar system 200 may be communication with a GPS network 300, a cellular network 310, a WiFi or low power long range network 360 and a plethora of electronic communication devices 400. The communication devices may be in connection with user cloud storage systems 500.

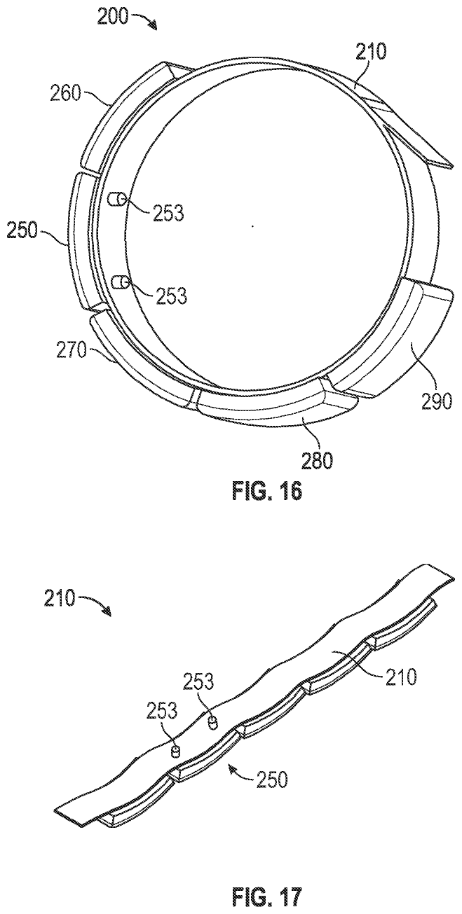

FIG. 16 depicts a disclosed modular collar system 200 which may comprise a flexible collar base 210 or connective band. The flexible collar base may retain a central module 270 and a plurality of axillary modules. In the present example, an axillary module 250 with animal sensors 253 may obtain animal information and transmit the information to the central module. The animal sensors may also act as means of transmission for shocking the animal.

Axillary modules 260, 280, 290 and others not shown may comprise third party hardware and software and communicate with the central module 270. Auxiliary modules may contain components for communications, RFID for pet door control, and other functions as described above.

FIG. 17 depicts a bottom perspective view of a modular collar system 200 which may comprise a flexible collar base 210, a central module and auxiliary modules. An axillary module 250 with animal sensors 253 is shown.

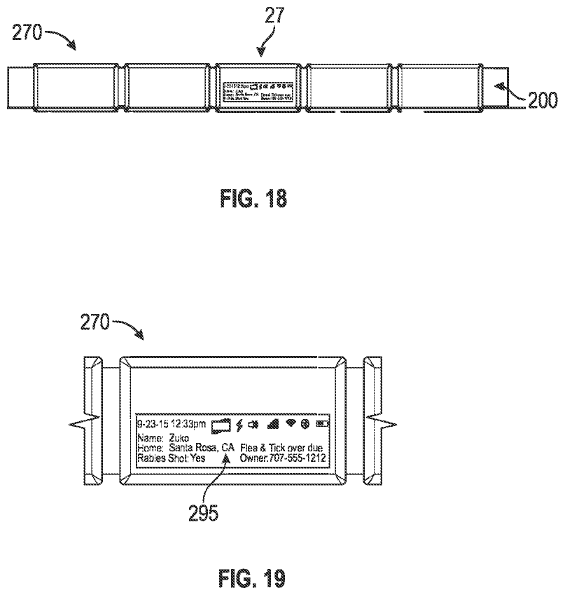

FIG. 18 depicts a top plan view of a modular collar system 200 comprising a central module 270, with the central module comprising a graphical interface, shown in more detail in FIG. 19.

FIG. 19 depicts an expanded view of FIG. 18 and shows a graphical interface 295 of a disclosed central module 270. The graphical interface may include animal identification information, medical information, such as rabies shots, owner contact information, sensor information and other system information.

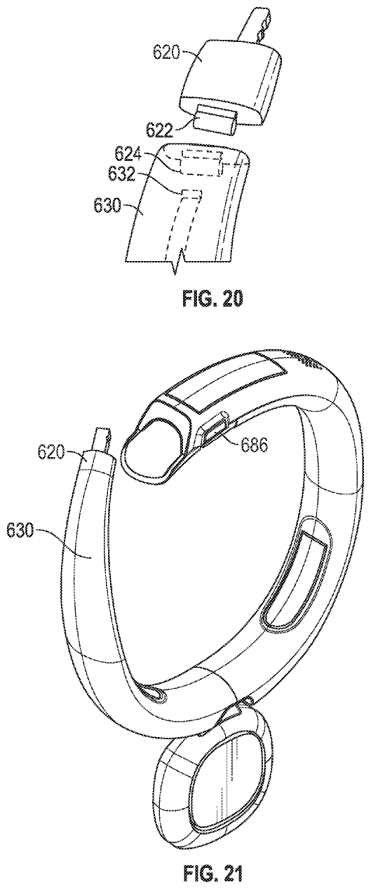

FIG. 20 depicts a latch tongue base 620 having a lock insert 622, the lock insert 622 may fit into or comport with a void 624 for the lock insert, the void 624 defined within the latch tongue body 630. The latch tongue body 630 may contain a Hall effect sensor 632 which changes state in the event of the collar being in a closed or open position. The Hall effect sensor 632 may be in communication with the CPU and other collar electronics to report the closed or open state of the collar. An open collar may trigger a lost collar function as described herein.

FIG. 21 depicts a disclosed collar and attached battery system.

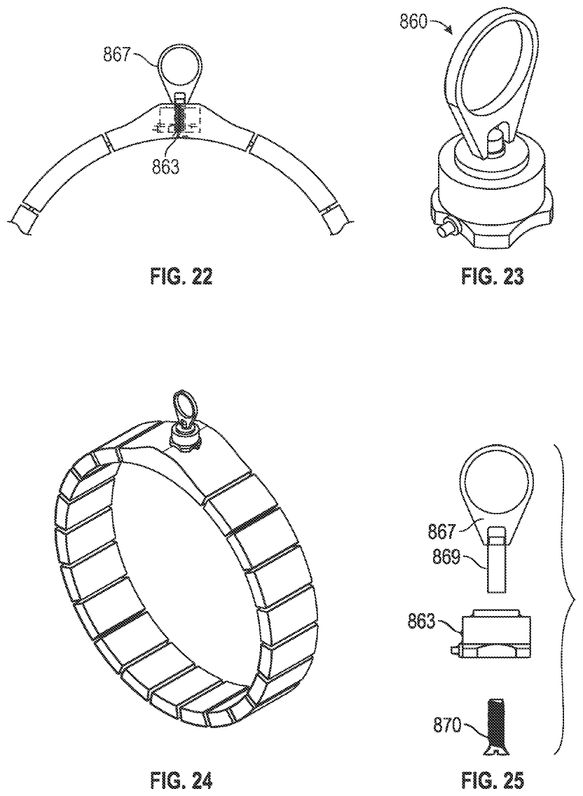

FIG. 22 depicts a swivel type D ring system sometimes used with a collar designed for leash use. The D ring 867 may retain a leash and a D ring may be connected with a swivel (869 FIG. 25) and/or load cell body 863. A load cell body may sense pull, moments of pressure or other forces exerted by the pet upon the leash and report such forces to the CPU and/or other electronic components of the collar. The reported forces may be used by the collar to trigger collar vibrations dissuade the pet from pulling upon the collar. The reported lease forces may be used for other collar/dog training functions.

FIG. 23 depicts a disclosed load cell assembly. The electrical and/or mechanical connection points to the CPU and/or other collar components are not shown.

FIG. 24 depicts a disclosed collar having a disclosed load cell assembly with a swivel D ring embodiment.

FIG. 25 depicts an exploded view of a load cell assembly which may comprise a D ring 867, attached to a swivel 869, which may be mated to or comport with a load cell body 863. A fastener 870 may be used to help retain the swivel 869.

Other attributes, systems are disclosed herein overcome shortfalls in the prior art and include the following.

The modularity of the collar presents new attributes and advantages. The functionality of the collar can be modified by adding electronic modules to the base collar to increase overall functionality. The circuitry of the base collar recognizes the new module and provides power, core processing power, memory storage, RF communications, and graphical display to enable intended features of the added module. Additional modules can include functionality for opening of pet doors, invisible fences, vibration training, electric shock training, ultrasonic and audible sound training, additional RF communications, video cameras, as well as working with existing manufacturer products. The module feature of the collar may be an open hardware platform thereby allowing third-party developers the ability to build new modules.

A new lost animal mode or lost animal state provides new advantages in pet recovery. With a disclosed collar in use, a pet owner may configure a polygon of pet confinement using a series of three or more longitude and latitude coordinates. A collar GPS chip can determine if the pet is inside or outside of the pet owner's defined area of pet confinement. When the collar's GPS chip determines that the dog is outside the area of confinement or if the GPS chip is not able to connect to the any previously connected smartphones using Bluetooth, then the collar switches to lost animal mode.

In a disclosed lost animal mode, the LED lights begin flashing, the display displays the pet's name and owner's phone number, and an audio message announcing the lost animal's name is played over the speaker at high volume. This messaging repeated at a configurable frequency and the rest of the collar goes into low power mode. If a long range radio frequency module is installed, then the owner is notified of the animal being lost and the lost animal's coordinates at regular intervals.

A disclosed lost collar mode provides valuable information and features to pet owners. In the normal use of any animal collar, the collar is known to come off of the animal and the collar cannot be found.

A disclosed collar is designed to assist the user in finding the collar when one of two conditions exist. The first condition is for the collar that includes a breakaway feature. When the collar breaks away from the animal when the male portion pops out of the female portion an electric signal is triggered indicating the collar has come off. The second condition is if the motion sensor does not sense any motion for more than 24 hours. If either of these conditions are met, then the collar's Lost Collar Mode is triggered. In this mode, the collar will go into sleep mode and wakes up several times after night fall at the top of the hour and sounds an alarm over the speaker and flashes the LED lights for several minutes. This messaging increases the probability of the owner finding the lost collar. Triggering the lost collar mode after night fall and at the top of an hour overcomes shortfalls in the art as a searcher will know when to expect an audio and/or visual signal. The visual signal will be more noticeable after nightfall.

Disclosed embodiments assist in behavior capture and behavior modification. When the owner of an animal wearing this collar observes behavior that is of interest, the owner can use the collar's smart phone app to record video of this behavior. When this is done the motion sensor data and microphones audio data is collected by the collar, sent to the smart phone and is time synchronized with the video. This package of information is then shared with developers. This allows developers to use this information as a behavior “print” that can be used programmatically to initiate new or existing actions on the collar to encourage or discourage such behavior.

The “print” of the behavior can be recognized in the future as the accelerometers in the collar may transmit data to the collar's internal computer system. The accelerometer data may be matched to the prior recorded “print” of behavior labeled as interesting by the owner. Upon such a match the owner may be notified via the electronic means disclosed herein.

Disclosed embodiments may include a bird deterrent mode wherein the presence of birds may be perceived or sensed by the collar's motion sensors and/or microphones. If appropriate, birds may be deterred by use of the collar's speaker and display system by use of sound and light. The display system may produce flashing LED light as well as UV LED light.

Disclosed embodiments may include a Not My Feeding Bowl function. Such a function may include the use of a Bluetooth chip that can detect Bluetooth beacon signals from other Bluetooth chips. A pet's feeding bowl can be configured with a Bluetooth beacon that is assigned to the pet's collar. At this point, when the animal approaches another feeding bowl with a Bluetooth beacon that is not recognized by the collar, the collar persuades the pet to leave the feeding bowl through audio command, vibration or electric shock. Disclosed embodiments may include a shock module and vibration module attached to a collar.

Similar to the Not My Feeding Bowl feature, a Stay Away function, using a Bluetooth bacon, may be used to prevent the animal from entering areas the animal is not desired such as bedrooms, kitchen, and dining room.

Disclosed embodiments may include a Force Pull Trigger function used with a disclosed D ring system. When the collar's D-ring is pulled with sufficient force, the load cell sensor signal triggers various actions in the collar that can be used in training as well as discouraging pulling of the collar. Other actions and/or behavioral modifications may also be encouraged.

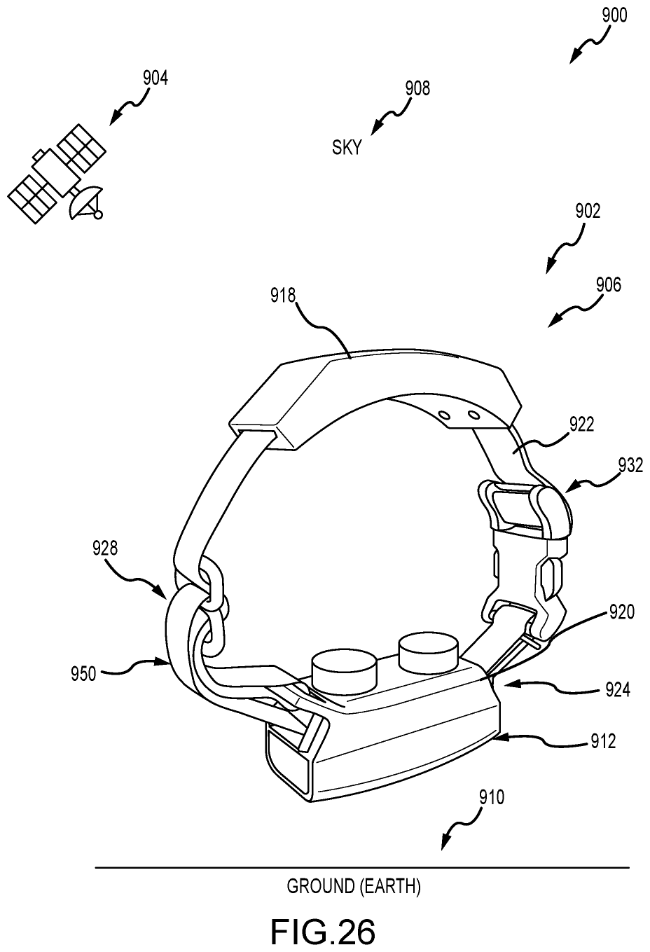

Turning to FIG. 26, a system 900 for tracking a collar system 902 is shown. The system 900 includes a Global Position System (“GPS”) comprising one or more satellites 904 configured to provide tracking information to a tracking device 906 disposed on a collar 922 of the collar system 902. It will be appreciated that in some embodiments, any positioning system may be used to provide tracking information. In some embodiments, the tracking device 906 may be housed in a first housing 918. In other embodiments, the collar system 902 may not include the first housing 918 (e.g., the one or more antennas and any other components may be fixed to the collar 922 and/or may be exposed to the atmosphere). The tracking device 906 comprises one or more antennas for receiving the tracking information. The tracking device 906 may also comprise one or more antennas for receiving other information such as, for example, radio communications including cellular communications, Bluetooth communications, Wi-Fi communications, and/or any other radio communications and/or frequencies.

The tracking device 906 may also comprise a transmitter for transmitting the tracking information to, for example, a handheld GPS device. In some embodiments, the tracking device 906 may include a processor for processing the tracking information, and a transmitter for transmitting the processed tracking information (e.g., coordinates obtained from processing the tracking information) to a handheld GPS device, a computing a device, a cellular device, or any other device. It is desirable for the tracking device 906 to be positioned facing the atmosphere or sky 908 so that the one or more antennas may face the one or more satellites 904. A tracking device on a conventional collar is typically the heaviest component on the collar. As such, tracking devices on conventional collars tend to cause the collar to rotate on a pet until the tracking device is facing the ground 910 and typically remains facing the ground 910 as a pet moves.

To counteract such movement, the collar system 902 includes a bottom assembly 924 disposed opposite the tracking device 906 on the collar 922. The bottom assembly 924 is designed to weight more than the tracking device 906 to keep the bottom assembly 924 positioned downward towards the ground 910 (e.g., near a throat of a pet) such that the tracking device 906 remains positioned upward (e.g., on top of a pet's neck) towards the sky 908. As such, the collar system 902 is self-orienting as gravity will cause the bottom assembly 924 to rotate downward and remain downward, thus rotating and keeping the tracking assembly 906 upward.

As shown, the bottom assembly 924 includes a battery 912 positioned opposite the tracking device 906. In some embodiments, the battery 912 may be removable from the collar system 902. In some embodiments, the battery 912 may be housed or attached to a second housing 920. In other embodiments, the battery 912 may not include the second housing 920. The bottom assembly 924 may also include one or more wires and/or a writing harness 950 enclosed in the collar 922. Power may be transmitted from the battery 912 to the tracking device 906 via the wires and/or the wiring harness 950.

The bottom assembly 924, in some embodiments, may include, for example, the central module 270 and/or any auxiliary modules such as motion sensors, microphones, heartrate sensors, sensor modules, sensor packages, etc. In other embodiments, the bottom assembly 924 may include a communication device, which may comprise, for example a processor, a memory, and/or a transmitter. The communication device may be powered by, for example, the batter 912. In such embodiments, communications and/or information from the communication device may be transmitted to or received from the tracking device 906 via the wires and/or the wiring harness 950. In other embodiments, communications and/or information from the communication device may be transmitted to and/or received from the tracking device 906 wirelessly (e.g., using wireless radio frequency communication, using Bluetooth, etc.). The communication device may also be configured to transmit communications to another device (whether a computer, a handheld GPS device, a phone, or otherwise) whether via wires or wirelessly.

The collar system 902 also includes an adjustment assembly or adjustor 926 for adjusting a diameter of the collar 922. In the illustrated embodiment, the adjustment assembly or adjustor 926 includes a first strap 914, a second strap 916, and a slide 928, which will be described further below.

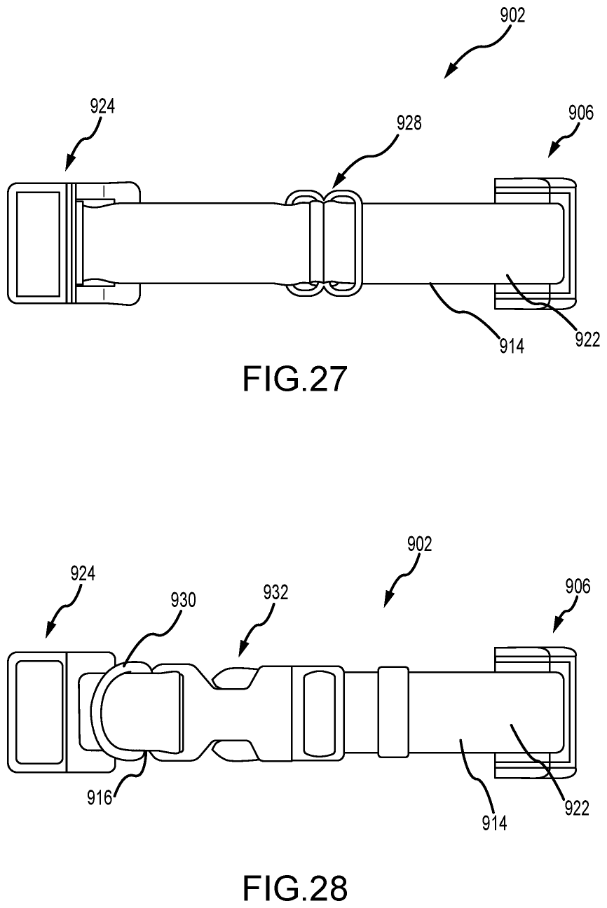

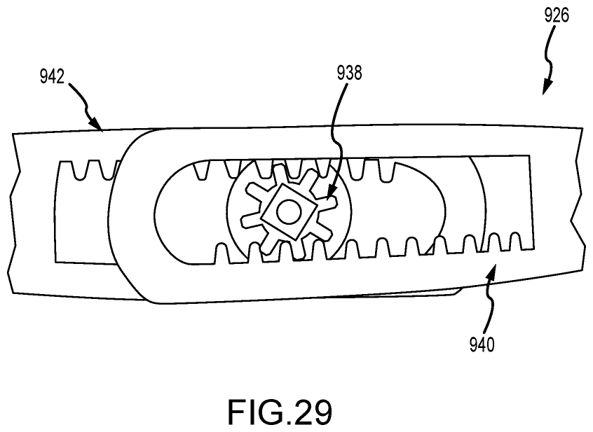

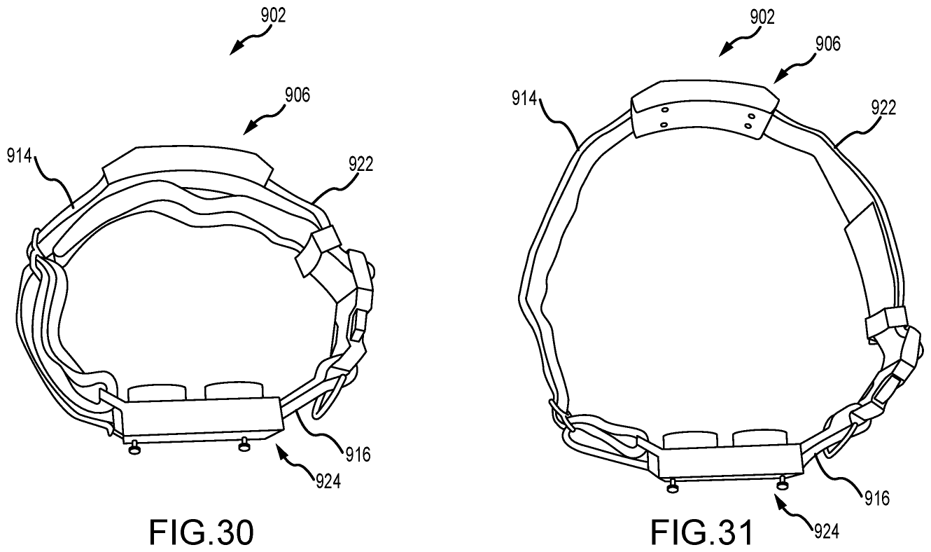

With reference to FIGS. 27-31, the adjustment assembly or adjustor 926 will be described. FIG. 27 depicts a right-side view of the collar system 902; FIG. 28 depicts a left-side view of the collar system 902; FIG. 29 depicts an embodiment of the adjustment assembly or adjustor 926; FIG. 30 depicts a rear view of the collar system 902 in a first configuration; and FIG. 31 depicts a rear view of the collar system 902 in a second configuration.

As visible in FIGS. 27-28 and 30-31, in embodiments where the adjustment assembly or adjustor 926 includes the first strap 914 and the second strap 916, the first strap 914 is coupled to the second housing 920 at a first end of the first strap 914. The first strap 914 is also threaded through the slide 928, the first housing 918, and coupled to a buckle 932 at a second end of the first strap 914. The second strap 916 couples the buckle 932 to the second housing 920. It will be appreciated that in other embodiments, any number of straps may be used to couple the first housing 918 and the second housing 920 to form the collar system 902. The collar system 902 may include a ring 930 (which may be any shape or size) coupled to the second strap 916 for receiving, for example, a clip of a leash or tags. Further, as shown, the tracking device 906 is removable fixed on the first strap 914, though in other embodiments, the tracking device 906 may be fixed to the first strap 914.

A length of the first strap 914 is adjustable via the slide 928. When the desired diameter of the collar system 902 is achieved, the first housing 918 may be adjusted to be positioned opposite the second housing 920. It will be appreciated that in some embodiments, the adjustment assembly or adjustor 926 may include more than one slide. For example, the collar system 902 may include a first slide on a first side of the collar 922 and a second slide on a second side of the collar 922. The first slide may be used to adjust a length of a strap on the first side and the second slide may be used to adjust a length of a strap on the second side.

In some embodiments, the first housing 918 may be fixed to the first strap 914, whether by having a releasable locking mechanism (e.g., a friction fit, a clamp, a press fit, use of hook and loop fabric, screws, etc.) or by permanent fixture (e.g., adhesion, rivets, or the like).

In other embodiments, the adjustment assembly or adjustor 926 may be or include, for example, hook and loop fabric (e.g., Velcro straps), ratchet straps, straps with buttons and/or snap buttons, or any other mechanism for adjusting a diameter of a collar.

As shown in FIGS. 28 and 30-31, the first strap 914 and the second strap 916 are coupled to the buckle 932. The buckle 932 is configured to open or close the collar system 902 such that the collar system 902 can be installed (when open) onto a neck of a pet, and then closed. In some embodiments, the collar system 902 may not include the buckle 932 and may include the breakaway collar system 600. In other embodiments, the collar system 902 may include any mechanism for opening and/or closing the collar system 902.

Turning to FIG. 29, another adjustment assembly or adjustor 926 is shown. The adjustment assembly or adjustor 926 includes a central gear 938 configured to adjust a right-side linear gear 940 and a left-side linear gear 942 equally and simultaneously, which adjusts a length of each side of the collar 922 on either side of the tracking device 906 (or first housing 918) equally at the same time. In other words, rotation of the central gear causes the right-side linear gear and the left-side linear gear to extend or retract from the central gear, thereby increasing or decreasing a diameter of the collar 922. It will be appreciated that a central gear, a left-side gear, and a right-side gear may be any type of gear.

The adjustment assembly or adjustor 926 may include a knob (not shown) to control the central gear 938. Rotating the knob in a first direction (e.g., clockwise) reduces the diameter of the collar 922 by reducing each side of the collar in equal lengths and rotating the knob in a second direction (e.g., counterclockwise) opposite the first direction increases the diameter of the collar 922 by increasing each side of the collar 922 in equal lengths. The central gear 938 ensures that each side of the collar 922 is of equal length and that the tracking device 906 and the bottom assembly 924 are of equal distance from each other. Though not shown, the adjustment assembly or adjustor 926 may be disposed under the first housing 918 or the second housing 920, though it will be appreciated that the adjustment assembly or adjustor 926 may be positioned anywhere on the collar system 902. In such embodiments, the collar system 902 may include a buckle to enable opening and closing of the collar 922.

It will be appreciated that the adjustment assembly or adjustor 926 may include any mechanism by which to adjust a diameter of the collar 922. For example, U.S. Pat. No. 2,205,742 to Bowers and incorporated by reference describes an example adjustment mechanism for adjusting a headband.

Turning to FIGS. 30 and 31, the collar system 902 is shown in a first configuration and a second configuration, respectively. Using the adjustment assembly or adjustor 926, the collar 922 may be moved between the first configuration and the second configuration. The collar 922 has a minimum diameter when at the first configuration and a maximum diameter when at the second configuration. It will be appreciated that the collar 922 may be used at any diameter between the minimum diameter and the maximum diameter.

As shown and previously described, at any configuration (e.g., at any diameter), the tracking device 906 and the bottom assembly 924 are positioned on opposite sides of the collar 922 from each other. In other words, the tracking device 906 and the bottom assembly 924 are approximately equal distance from each other where each portion of the collar 922 between the tracking device 906 and the bottom assembly 924 are about equal in length. This enables the tracking device 906 and the bottom assembly 924 to be positioned for optimal performance of the tracking device 906 at a highest point of a neck of a pet and the bottom assembly 924 at a lowest point of the neck.

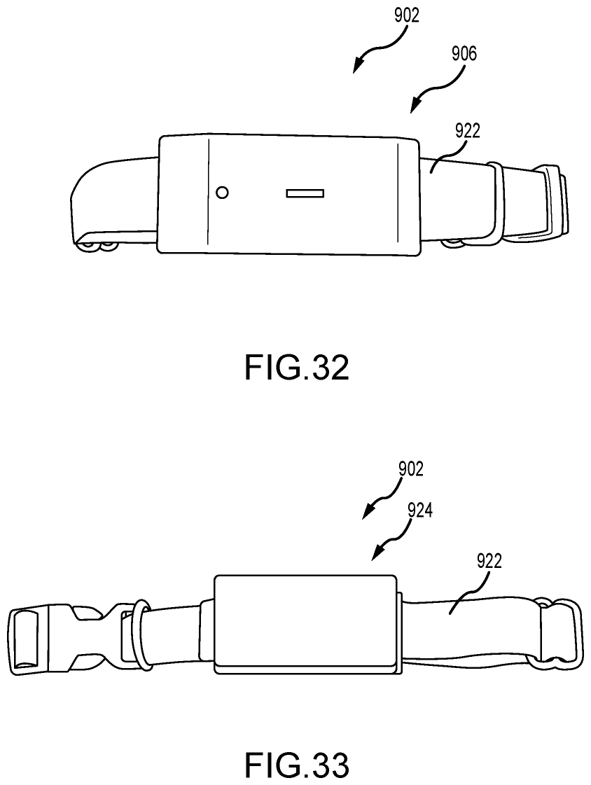

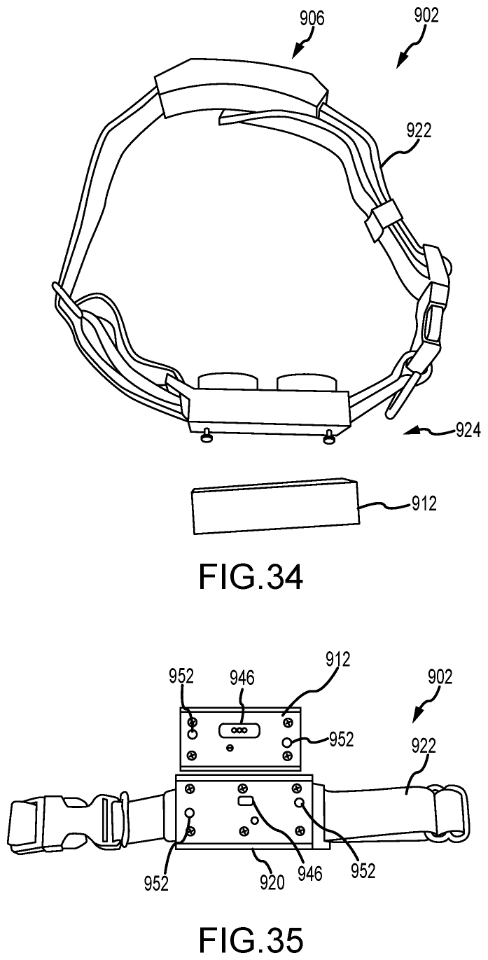

Turning to FIGS. 32-35, the bottom assembly 924 will be further described. FIG. 32 depicts a top view of the collar system 902; FIG. 33 depicts a bottom view of the collar system 902; FIG. 34 depicts a front view of the collar system 902 with the battery 912; and FIG. 35 depicts a bottom view of the collar system 902 with the battery 912 detached. As shown, the second housing 920 and the battery 912 includes external electrical contacts 946 for a battery 912 that is removable. It will be appreciated that in some embodiments, the battery 912 may not be removable. It will also be appreciated that, though not shown, the bottom assembly 924 may include any number of sensors, electrical components, mechanical components, or electromechanical components. Further, the bottom assembly 924 may include a rigid circuit board and/or a flexible circuit board. The second housing 920 and the battery 912 may further include corresponding locking attachments 952 for securing or fixing the second housing 920 to the collar system 902.

Disclosed embodiments may include the following items.

Item 1. A modular break a way collar system (600) with integrated electronic components used for pet tracking and pet training, the system comprising: machine readable instructions stored upon non-volatile memory, the machine readable instructions read by a CPU or MCU, the CPU in communication with a display system, speaker system, microphone system, a motion detection system, radio communication system, GPS and a detachable battery system; a collar detachment system comprising a collar body having a first end attached to a latch tongue body (630), the latch tongue body attached to a latch tongue base (620), the latch tongue base attached to a latch tongue (610), the latch tongue comprising teeth (612), the collar body having a second end comprising a female void (680) the female void defined by a lower lip (680) and upper arch (684), the second end of the collar body containing a ratcheting mechanism (686) the ratcheting mechanism comporting to the teeth of the latch tongue; the machine readable instructions including a behavior capture function wherein user selected motion data from the motion detection system is recorded to the non-volatile memory and future instances of the user selected motion data trigger a message to a pet owner; the machine readable instructions including a lost collar function wherein a radio signal is generated by the radio communication system in the event of either 1) the latch tongue body separated from the latch tongue base or 2) the motion detection system fails to record motion during a predetermined time period; the machine readable instructions including a bird deterrent function wherein the display produces LED flashes, UV LED flashes and the speaker system produces audio sounds in the event of a bird being perceived by either 1) the microphone system or the 2) motion detection system; the machine readable instructions including a lost animal function wherein the CPU or MCU and non-volatile memory accept user entered coordinates delineating a polygon area of containment, in the event that the GPS senses that the collar is outside of the polygon area of containment, the display system displays an animal's name, an owner's name and an owner's phone number, the speaker system generates an audio message containing a message indicating that the animal is lost and containing the owner's name and the owner's phone number and a message is transmitted by the radio communication system.

Item 2. The system of above wherein the microphone system comprises a pet microphone and an ambient sound microphone.

Item 3. The system of above wherein the ambient sound microphone is located at the top of the collar and the pet microphone is located within the inside surface of the collar upon the animal's throat.

Item 4. The system of above wherein the display system comprises the display of images and text to comprise a human interface output and wherein the speaker system comprises audio messages to further comprise the human interface output.

Item 5. The system of above wherein signals generated by the motion detection system and microphone system are transmitted by the radio communication system to a pet owner and used for the human interface output.

Item 6. The system of above wherein the machine readable instructions further include a lost animal mode that is triggered upon the collar being placed in an open position which in turn results in the display system displaying the pet's name and owner's phone number and the speaker system announcing the last pet's name, and the radio communication system sending a message to the pet owner.

Item 7. The system of above wherein the machine readable instructions include a lost collar mode that is triggered upon either a) the collar is placed in the open position, or 2) the motion detection system fails to report motion for a predetermined amount of time, with the lost collar mode placing the collar into a sleep mode with the sleep mode interrupted after night fall at the top of the hour generating alarm sounds over the speaker and flashes upon the LED lights for a predetermined amount of time.

Item 8. The system of above wherein the machine readable instructions include a behavior capture and behavior modification mode wherein the pet owner, upon observing pet behavior of interest, may trigger a collar smart phone application to record video of the behavior of interest, during the recording, the motion sensor data and microphones audio data are collected by the collar, sent to the pet owner's smart phone and is time synchronized with the video, the time synchronized data used to create a behavior print that may be recognized in the future by the collar with such a recognition used to trigger collar actions to either encourage or discourage the recognized behavior.

Item 9. The system of above wherein the machine readable instructions include a bird deterrent mode wherein the presence of birds is perceived by the motion detection system and/or the microphone system, upon the perception of one or more birds, the speaker system produces sound and the display system produces flashing light.

Item 10. The system of above wherein the machine readable instructions include a not my bowl function wherein a the collar includes a Bluetooth chip detecting welcoming Bluetooth beacon signals from the pet's assigned feeding bowl and the collar's Bluetooth chip detecting unwelcoming Bluetooth beacon signals from other pet food bowls and owner defined out of bound areas, with the receipt of unwelcoming Bluetooth signals triggering negative commands from the collar comprising audio commands, vibration and electric shock.

Item 11. An exoskeleton collar (800) comprising: a plurality of connected outer shell components (810), one or more modules (820), one or more speakers (840) and one or more display screens (850); a load cell assembly comprising a D-ring connected to the load cell assembly, with the load cell assembly measuring forces exerted upon the D-ring with the measured forces reported to a main module, the main module comprising machine readable instructions stored upon non-volatile memory, the machine readable instructions read by a CPU or MCU, the CPU or MCU in communication with a display system, speaker system, a motion detection system, microphone system, radio communication system, GPS and a detachable battery system; the machine readable instructions further including a force pull trigger function using the measured forces upon the D ring to trigger collar actions to discourage a pet's pulling upon the collar, the collar actions comprising vibration, sound, and electric shock; a communication system between the modules, the communication system comprising an open software and open hardware bus protocols.

Item 12. The system above wherein the microphone system comprises a pet microphone and an ambient sound microphone.

Item 13. The system above wherein the ambient sound microphone is located at the top of the collar and the pet microphone is located within the inside surface of the collar upon an animal throat area.

Item 14. The system above wherein the display system comprises the display of images and text to comprise a human interface output and wherein the speaker system comprises audio messages to further comprise the human interface output.

Item 15. The system above wherein signals generated by the motion detection system and microphone system are transmitted by the radio communication system to a pet owner and comprise the human interface output.

Item 16. The system above wherein the machine readable instructions further include a lost animal mode that is triggered upon the collar being placed in an open position which in turn results in the display system displaying the pet's name and owner's phone number and the speaker system announcing the lost pet's name, and the radio communication system sending a message to the pet owner.

Item 17. The system above wherein the machine readable instructions include a lost collar mode that is triggered upon either a) the collar is placed in the open position, or 2) the motion detection system failing to report motion for a predetermined amount of time, with the lost collar mode placing the collar into a sleep mode with the sleep mode interrupted after night fall at the top of the hour generating alarm sounds over the speaker and flashes upon the LED lights for a predetermined amount of time.

Item 18. The system above wherein the machine readable instructions include a behavior capture and behavior modification mode wherein the pet owner, upon observing pet behavior of interest, may trigger a collar smart phone application to record video of the behavior of interest, during the recording, the motion sensor data and microphones audio data is collected by the collar, sent to the owner's smart phone and is time synchronized with the video, the time synchronized data used to create a behavior print that may be recognized in the future by the collar with such a recognition used to trigger collar actions to either encourage or discourage the recognized behavior.

Item 19. The system of above wherein the machine readable instructions include a bird deterrent mode wherein the presence of birds is perceived by the motion detection system and/or the microphone system, upon the perception of one or more birds, the speaker system produces sound and the display system produces flashing light.

Item 20. The system above wherein the machine readable instructions include a not my bowl function wherein a the collar includes a Bluetooth chip detecting welcoming Bluetooth beacon signals from the pet's assigned feeding bowl and the collar's Bluetooth chip detecting unwelcoming Bluetooth beacon signals from other pet food bowls and owner defined out of bound areas, with the receipt of unwelcoming Bluetooth signals triggering negative commands from the collar comprising audio commands, vibration and electric shock.

The above detailed description of embodiments of the disclosure is not intended to be exhaustive or to limit the disclosure to the precise form disclosed above. While specific embodiments of, and examples for, the disclosure are described above for illustrative purposes, various equivalent modifications are possible within the scope of the disclosure, as those skilled in the relevant art will recognize. For example, while steps are presented in a given order, alternative embodiments may perform routines having steps in a different order. The teachings of the disclosure provided herein can be applied to other systems, not only the systems described herein. The various embodiments described herein can be combined to provide further embodiments. These and other changes can be made to the disclosure in light of the detailed description.

Any and all the above references and U.S. patents and applications are incorporated herein by reference. Aspects of the disclosure can be modified, if necessary, to employ the systems, functions and concepts of the various patents and applications described above to provide yet further embodiments of the disclosure. To further comply with written description and enablement requirements, the following patents and patent publications are also incorporated herein by this reference in their entireties: are the following: U.S. Pat. No. No. 8,783,212 to Bellon et. al.; U.S. Pat. No. No. 8,900,818 to Lemnell; U.S. Patent Publication No. 2007/0204804 to Swanson et. al.; U.S. Pat. No. 8,922,363 to So; U.S. Patent Publication No. 2015/0040839 to Goetzl et. al.; U.S. Pat. No. 7,862,057 to Milnes et. al.; U.S. Pat. No. 6,646,617 to Gaukel et. al.; U.S. Pat. No. 5,850,196 to Mowers; U.S. Pat. No. 10,004,208 to So; U.S. Pat. No. 2,205,742 to Bowers.

What is claimed is:

1. A self-orienting collar system, comprising:
a collar comprising at least one strap;
a tracking device positioned on the collar;
a bottom assembly positioned on the collar opposite the tracking device, the bottom assembly having a weight greater than a weight of the tracking device; and
an adjustment assembly for adjusting a diameter of the collar,
wherein the tracking device and the bottom assembly remain positioned opposite each other when the diameter of the collar is adjusted.

2. The self-orienting collar system of claim 1, wherein the bottom assembly includes a battery for supplying power to the tracking device.

3. The self-orienting collar system of claim 1, wherein the tracking device comprising one or more antennas for receiving tracking information from a Global Positioning System.

4. The self-orienting collar system of claim 2, further comprising a writing harness integrated with the collar and configured to deliver power from the battery to the tracking device.

5. The self-orienting collar system of claim 1, further comprising a first housing configured to house the tracking device and a second housing configured to house the bottom assembly.

6. The self-orienting collar system of claim 1, wherein the adjustment assembly comprises a central gear coupled to a right-side gear and a left-side gear, wherein rotation of the central gear causes the right-side linear gear and the left-side linear gear to at least one of extend or retract from the central gear, thereby increasing or decreasing a diameter of the collar.

7. The self-orienting collar system of claim 1, wherein the weight of the bottom assembly causes the bottom assembly to face a ground and the tracking device to face a sky opposite the ground when the collar is installed on a neck of a pet.

8. The self-orienting collar system of claim 2, further comprising:
at least one auxiliary module configured to receive power from the battery.

9. The self-orienting collar system of claim 8, wherein the at least one auxiliary module comprises sensors, the sensors comprising at least one of motion sensors, microphones, or heartrate sensors.

10. A self-orienting collar system comprising:
a collar comprising at least one strap;
a tracking device positioned on the collar;
a bottom assembly positioned on the collar opposite the tracking device, the bottom assembly having a weight greater than a weight of the tracking device; and
an adjustor for adjusting a diameter of the collar, the adjustor comprising the at least one strap and a slide, the slide configured to adjust a length of the at least one strap,
wherein the tracking device and the bottom assembly remain positioned opposite each other when the diameter of the collar is adjusted.

11. The self-orienting collar system of claim 10, wherein the bottom assembly includes a battery for supplying power to the tracking device.

12. The self-orienting collar system of claim 11, further comprising a writing harness integrated with the collar and configured to deliver power from the battery to the tracking device.

13. The self-orienting collar system of claim 10, wherein the tracking device comprising one or more antennas for receiving tracking information from a Global Positioning System.

14. The self-orienting collar system of claim 10, further comprising a first housing configured to house the tracking device and a second housing configured to house the bottom assembly.

15. The self-orienting collar system of claim 10, wherein the weight of the bottom assembly causes the bottom assembly to face a ground and the tracking device to face a sky opposite the ground when the collar is installed on a neck of a pet.

16. The self-orienting collar system of claim 11, further comprising:
at least one auxiliary module configured to receive power from the battery.

17. The self-orienting collar system of claim 16, wherein the at least one auxiliary module comprises sensors, the sensors comprising at least one of motion sensors, microphones, or heartrate sensors.

18. A self-orienting collar system, comprising:
a collar comprising at least one strap;
a tracking device positioned on the collar;
at least one auxiliary module;
a bottom assembly positioned on the collar opposite the tracking device and comprising a battery configured to supply power to the tracking device and the at least one auxiliary module, the bottom assembly having a weight greater than a weight of the tracking device; and
an adjustment assembly for adjusting a diameter of the collar,
wherein the tracking device and the bottom assembly remain positioned opposite each other when the diameter of the collar is adjusted.

19. The self-orienting collar system of claim 18, wherein the at least one auxiliary module comprises sensors, the sensors comprising at least one of motion sensors, microphones, or heartrate sensors.

20. The self-orienting collar system of claim 18, wherein the adjustment assembly comprises a central gear coupled to a right-side gear and a left-side gear, wherein rotation of the central gear causes the right-side linear gear and the left-side linear gear to at least one of extend or retract from the central gear, thereby increasing or decreasing a diameter of the collar.
